(19) United States
(12) Patent Application Publication
(10) Pub. No.: US 2021/0390453 A1
(43) Pub. Date: Dec. 16, 2021

(54) REDUCING COVARIATE DRIFT IN MACHINE LEARNING ENVIRONMENTS

(71) Applicant: Jaxon, Inc., Boston, MA (US)

(72) Inventors: Bradley Hatch, Saratoga Springs, UT (US); Gregory Harman, Castro Valley, CA (US)

(21) Appl. No.: 17/339,715

(22) Filed: Jun. 4, 2021

Related U.S. Application Data
(60) Provisional application No. 63/039,069, filed on Jun. 15, 2020.

(51) Int. Cl. G06N 20/00

(52) U.S. Cl. CPC G06N 20/00

(57) ABSTRACT

Techniques and apparati for organizing and dividing machine learning datasets (e.g., into training and test sets) to address data covariate drift. By utilizing clustering on a drift-invariant representation of the data feature space, and then sampling examples independently from each duster, data drift can be minimized between or among the divided datasets.

### RELATED PATENT APPLICATION

The present patent application claims the benefit of commonly owned U.S. provisional patent application 63/039,069 filed Jun. 15, 2020, entitled “Reducing Covariate Drift in Machine Learning Data Environments”, which provisional patent application is hereby incorporated by reference in its entirety into the present patent application.

### TECHNICAL FIELD

This invention pertains to the field of artificial intelligence, and, specifically, to improving the accuracy of results obtained using machine learning.

Testing machine learning models almost always involves a simple pattern:
1. Take the available data.
2. Split off a fixed percentage (20% is a common rule of thumb) and call it the test set. Importantly, this split is typically performed via random sampling.
3. (Optionally) further subdivide a development or validation set.
4. Train a model on the remaining 80% of data, called the training data.
5. Use the trained model to make predictions on the examples (X) in the test set, and compare the results to the original set of “ground truth” test labels (Y).

The purpose of the test dataset is to estimate the model's ability to generalize when applied to previously-unseen data the model's actual performance when applied to new data “in the field”). When the test dataset is drawn at random, or via other sub-optimal methods, two implicit and troubling assumptions are made:
1. The test dataset does indeed exactly capture the richness and distribution of the training dataset.
2. The training dataset does indeed exactly capture the richness and distribution of the unseen “real-world” data.

These assumptions hurt the test dataset's ability to accurately assess the model's performance, leading to suboptimal training and unrealistic expectations. Any such error between data environments is termed data drift; there are a number of types of drift that can impact models.

Data (covariate) drift occurs when overall label distribution stays the same, but the feature distribution of documents (X) changes. Time variance is the canonical example for covariate drift. For example, “Thou” is not used in modern text, and a model built using Old English would perform poorly when tasked with Tweet analysis.

Time is not the only dimension along which such drift can occur. Data might be sampled from different environments, all of which are simply approximations of a truly generalized domain, Was the dataset (from which, as a reminder, the test set is being split true to sampled distribution) representative? Continuing the social media example, perhaps the data was drawn disproportionately from a particular nationality, demographic group, or special interest group, any of which may have different language patterns and differently weighted topics of interest.

Addressing covariate drift can help improve and better measure generalization. Care must be taken when sampling or deriving test data to ensure that it covers the same areas in the same proportions as training data within the expected generalized environment, while avoiding latent biases within the training environment.

One solution pattern described in Zeng, Xinchuan, and Martinez, Tony, “Distribution-Balanced Stratified Cross-Validation for Accuracy Estimation,” http://citeseerx.ist.psu.edu/viewdoc/download:jsessioonid=112852395D6229BB994C279E9D10FABF?doi=10.1.1.23.8417&rep=rep1&type=pdf utilizes “KNN” as a document similarity metric to sort examples (X) within each class (Y). Sampling of test and training subsets then utilizes this sorting to ensure similar variations based on the KNN distance from a reference example.

### DISCLOSURE OF INVENTION

This invention describes a novel technique for organizing and dividing machine learning datasets (e.g., into training and test sets) to address the risks of data (covariate) drift. By utilizing clustering on a drift-invariant representation of the data feature space, and then sampling examples independently from each duster, data drift can be minimized between or among the divided datasets.

This novel technique additionally provides the (optional) means to strategically adjust the class distribution within either the original or training datasets, while protecting against covariate drift by capping the number of samples drawn from each duster using per-class quotas. This “flattening” of the distribution often helps machine learning models learn to identify rare classes in the event of a heavily skewed class distribution,

### BRIEF DESCRIPTION OF THE DRAWINGS

These and other more detailed and specific objects and features of the present invention are more fully disclosed in the following specification, reference being had to the accompanying drawings, in which:

FIG. 1 is a block diagram depicting a system-level view of the present invention and the environment in which it operates.

FIG. 2 is a flow diagram showing method steps that implement a preferred embodiment of the present invention.

### DETAILED DESCRIPTION OF PREFERRED EMBODIMENTS

The following detailed description includes references to the accompanying drawings, which form a part of the detailed description. The drawings show illustrations in accordance with example embodiments. These example, embodiments, which are also referred to herein as “examples,” are described in enough detail to enable those skilled in the art to practice the present subject matter. The embodiments can be combined, other embodiments can be utilized, or structural, logical, and/or electrical changes can be made without departing from the scope of what is claimed.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

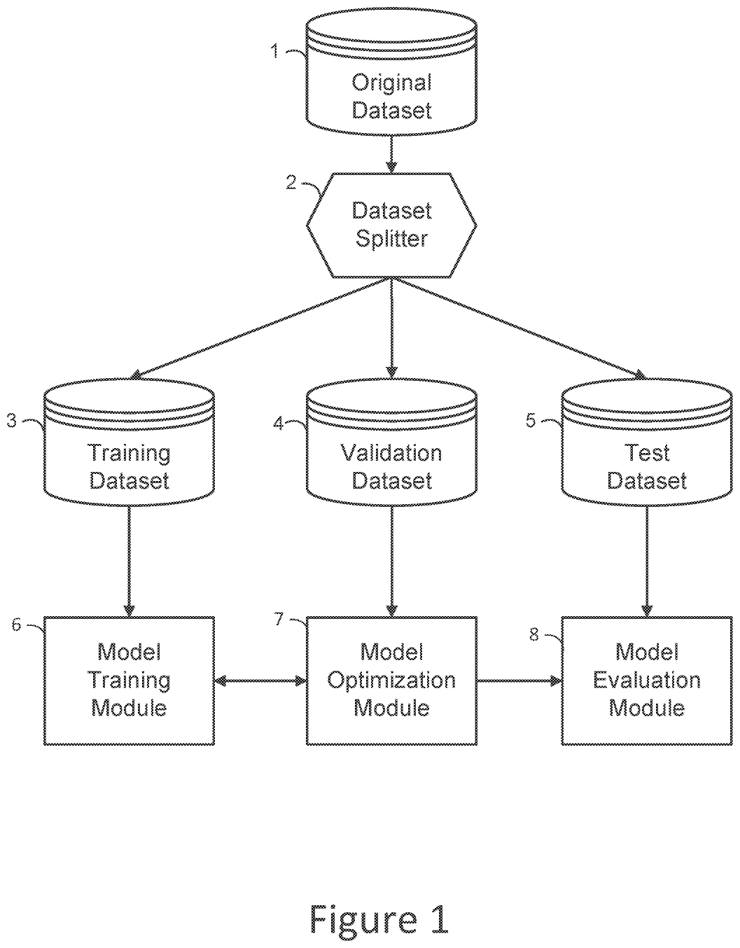

In order to train and evaluate a machine learning model, a dataset must be split and applied to this purpose. With reference to FIG. 1, the depicted modules carry out the following tasks;
1. Original Dataset 1 is processed by Dataset Splitter 2 in order to divide, it into Training Dataset 3, (optionally) Validation Dataset 4, and Test Dataset 5.
2. Model Training Module 6 utilizes Training Dataset 3 to train a candidate machine learning model.
3. If Validation Dataset 4 is in use, Model Optimization Module 7 is used to assess the model using inferences generated by the model on Validation Dataset 4 in order to optimally adjust model parameters. Steps 2 and 3 may be iterated.
4. The model is evaluated on target metrics by Model Evaluation Module 8 utilizing inferences made by the model on Test Dataset 5.

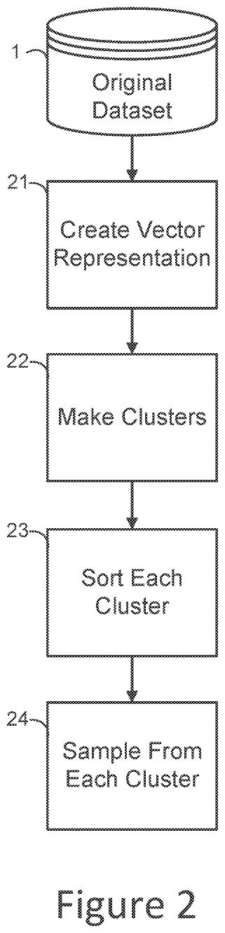

The present invention enables optimal splitting of datasets i.e., as an embodiment of the Dataset Splitter 2, into an arbitrary number of child datasets on a per-example basis in such a way as to minimize covariate drift. With reference to FIG. 2, exemplary method steps to accomplish this goal are:

At step 21, create a strategic vector representation W(X) to project X (Original Dataset 1) into a cohesive vector space. For text-based datasets, pretrained language models such as ULMFiT, BERT, and GPT2 can be utilized directly to create high-quality vector representations “out of the box.” The representation can be further extended to address concept drift by structuring W(X) to be invariant across environments, for example as described in Arjovsky, Martin, et al., “invariant Risk Minimization.” ArXiv:1907.02893 [Cs, Stat], Mar. 27, 2020, http://arxiv.org/abs/1907.02893].

At step 22, cluster all example representations VAX) for the dataset X, resulting in distinct meaningful coordinates for each example X. This clustering is performed independently for each class label Y, including the possibility of a null class value when targeting unsupervised machine learning tasks, or when class labeling has not yet been applied to the dataset. Mile it is typical for values of Y to align directly to designated classes (e.g. for a classification model), it is also possible to assign classes to bucket data for other problem types, such as value ranges for a continuous regression model.

At step 23, each cluster is sorted by descending distance between the vector coordinates W(X) for example X and the cluster's centroid coordinates.

At step 24, the process described by Zeng, supra, is then executed independently within each cluster, in which sampling is performed round-robin across clusters in order to group like examples along latent dimensions, normalizing any inherent distributions. Note that while Zeng utilizes a random example as the origin point for the document similarity sorting, our inclusion of duster sorting at step 23 allows an optimal choice for each subsequently sampled example.

A preferred method for carrying out the invention is summarized in the following paragraph:
Given: training dataset X (examples), Y (corresponding targets/labels)
Create a vector representation W(X) for X.
For all examples x_{y} such that examples x∈X belong to class y∈Y:
   Cluster x_{y} by W(x_{y}).
   For each duster c,
      Sort c using a document similarity metric such as KNN using the centroid document W(x_{y})_{c} as the reference.
      Sample fully from each duster according to the desired split between or among datasets (such as training/validation/test).

Note additionally that this process allows a dataset to be strategically augmented. New candidate examples can be added to the nearest duster and sorted into an existing instance of this process and correctly sorted; this supports ongoing growth of datasets. Inversely, a small or incohesive duster may represent an area of informational weakness within the dataset, New examples can be obtained or generated in such a way as to maximize their similarity (using the original document similarity metric combined with W(X)) to the lower-quality dusters.

### Advantageous Features

The following advantageous features are obtained by one using the present invention:
1. This invention renders machine learning test datasets resistant to covariate drift; they are more representative of the “real world” rather than being blindly split off from a training data environment, resulting in more production accuracy and less fall-off in the face of unforeseen or changing data conditions.

2. The drift remediation techniques of this invention can be applied to align test and training datasets and representations, as well as aligning the test dataset with our best estimate of that generalized environment.
3. Splits are not limited to two sub-datasets (e.g., train/test). This method can be used to subdivide a dataset into any number of smaller datasets, in any relative proportion to each other. Beyond direct training and testing of machine learning models, applications extend to any situation in which it is important to share portions of a dataset, while keeping sub-datasets as similar as possible. Contests, educational exercises, and compartmentalized security applications are an incomplete list.

Databases and software processes described in the present invention can be stored on computer-readable media, which store one or more sets of instructions and data embodying or utilized by any one or more of the methods or functions described herein. The data and instructions can also reside, completely or at least partially, within the computer's main memory and/or within the processors during execution by said computer system The computer's main memory and the processors also constitute machine-readable media.

Data and instructions comprising the present invention can further be transmitted or received over a communications network via a network interface device utilizing any one of a number of well-known transfer protocols (e.g., Hyper Text Transfer Protocol (HTTP), Controller Area Network, Serial, and Modbus). The communications network may include the Internet, local intranet, PAN, LAN, WAN, Metropolitan Area Network, VPN, a cellular network. Bluetooth radio, or an IEEE 802.9 based radio frequency network, and the like.

The term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methods of the present application, or that is capable of storing, encoding, or carrying data utilized by or associated with such a set of instructions. The term “computer-readable medium” shall accordingly be taken to include, but not be limited to, solid-state memories, optical and magnetic media. Such media can also include, without limitation, hard disks, floppy disks, flash memory cards, digital video disks, random access memory, read only memory, and the like.

The example embodiments described herein can be implemented in an operating environment comprising computer-executable instructions installed on a computer, in software, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written utilizing any number of suitable programming languages such as, for example, Java™, C, C++, C#, .NET, Adobe Flash, Perl, UNIX Shell, Visual Basic or Visual Basic Script, Objective-C, Scala, Clojure, Python, R, Julia, Go, Rust, Kotlin, PHP, Ruby, JavaScript or other compilers, assemblers, interpreters, or other computer languages or platforms, as one of ordinary skill in the art will recognize.

The above description is included to illustrate the operation of preferred embodiments, and is not meant to limit the scope of the invention. The scope of the invention is to be limited only by the following claims, From the above discussion, many variations will be apparent to one skilled in the art that would yet be encompassed by the spirit and scope of the present invention.

What is claimed is:

1. Method for organizing a machine learning input dataset in a manner that intentionally reduces covariate drift, said method comprising the steps of:
dividing the input dataset into a training dataset and a test dataset;
using the training dataset to train a candidate machine learning model; and
evaluating the model on target metrics using inferences made by the model on the test dataset; wherein:
the step of dividing the input dataset splits the input dataset into a plurality of child datasets in a manner that minimizes covariate drift.

2. The method of claim 1 wherein:
the step of dividing the input dataset comprises dividing the input dataset into a training dataset, a test dataset, and a validation dataset; and
the method further comprises the step of using a model optimization module to assess the model using inferences generated by the model on the validation dataset in order to optimally adjust model parameters.

3. The method of claim 1 wherein the step of dividing the input dataset comprises:
creating a strategic vector representation W(X) to project X into a cohesive vector space, where X is the input dataset;
clustering all example representations W(X) for the input dataset;
sorting the cluster by descending distance between the vector coordinates W(X) for example X and the cluster's centroid coordinates; and
performing round-robin sampling across dusters in order to group like examples along latent dimensions.
